(19) United States
(12) Patent Application Publication
(10) Pub. No.: US 2024/0349798 A1
(43) Pub. Date: Oct. 24, 2024

(54) HEATING ATOMIZATION ASSEMBLY, HEATING ATOMIZATION DEVICE, AND ELECTRONIC ATOMIZER COMPRISING HEATING ATOMIZATION DEVICE

(71) Applicant: SHENZHEN HUACHENGDA PRECISION INDUSTRY CO. LTD., Shenzhen (CN)

(72) Inventor: Ping CHEN, Shenzhen (CN)

(73) Assignee: SHENZHEN HUACHENGDA PRECISION INDUSTRY CO. LTD., Shenzhen, GD (CN)

(21) Appl. No.: 18/035,937

(22) PCT Filed: Jan. 21, 2022
(86) PCT No.: PCT/CN2022/073219

§ 371 Date: May 9, 2023

(51) Int. Cl. A24F 40/46; A24F 40/10; A24F 40/44; H05B 3/03; H05B 3/46

(52) U.S. Cl. CPC A24F 40/46; A24F 40/10; A24F 40/44; H05B 3/03; H05B 3/46; H05B 2203/021

(57) ABSTRACT

A heating atomization assembly, a heating atomization device, and an electronic atomizer comprising the heating atomization device. The heating atomization assembly includes a liquid transfer unit and a heating unit. At least one liquid inflow surface is disposed on a side wall of the liquid transfer unit. The heating unit includes an embedded part and an atomization part The heating atomization device includes a sealing element, a base, and a heating atomization assembly disposed between the base and the sealing element. The electronic atomizer includes an atomizer shell. A heating atomization device is disposed in the atomizer shell, and a liquid storage chamber and an air guide tube are disposed between the atomizer shell and the heating atomization device. Liquid around the liquid inflow surface is preheated to reduce the viscosity of the liquid with a high viscosity and increase the flow rate of the liquid.

### FIELD

The invention belongs to the technical field of atomization, and particularly relates to a heating atomization assembly, a heating atomization device, and an electronic atomizer comprising the heating atomization device.

### BACKGROUND

Electronic atomization technology is a technology for electrically heating liquid to the boiling point to generate steam, and is widely used in the electronic cigarette field at present. With the innovation and development of the atomization technique, the electronic atomization technique is used in more other fields such as the beauty field and the medical field. However, the viscosity of atomized liquid varies drastically with the change of the concentration of the atomized liquid, which will in turn lead to a different flow rate of the atomized liquid in a liquid transfer material, and the flow velocity of the atomized liquid reaching a heating unit will change greatly. Thus, the structure of a heating atomization assembly should be innovated to ensure that the atomized liquid can also be quickly transferred to an atomization area of the heating atomization assembly when the concentration of the atomized liquid is high. It can be known, by testing the kinematic viscosity of liquid at different temperatures, that the kinematic viscosity of liquid will be reduced at a high temperature, thus increasing the flow rate of the liquid. With the viscosity of an oil substance prepared from propylene glycol and glycerol with a ratio of 5:5 at different temperatures as an example, the viscosity of the oil substance at the temperature of 0° C. is high, and the viscosity of the oil substance is low when the temperature rises to 100° C. The different viscosities of the liquid may cause the following problems: if the viscosity is too high, core burning will take place due to insufficient liquid supply to an atomization surface of the liquid transfer unit; and if the viscosities of liquids are greatly different, liquid with a high viscosity will be supplied slowly, while liquid with a low viscosity will be supplied quickly, so the overall atomization effect will be unsatisfactory.

### SUMMARY

In view of the defects of the prior art, the technical issue to be solved by the invention is to provide a heating atomization assembly which can increase the liquid supply rate of a liquid transfer unit and avoid core burning caused by insufficient liquid supply, a heating atomization device, and an electronic atomizer comprising the heating atomization device.

The technical solution adopted by the invention to solve the above technical issue is to provide a heating atomization assembly which comprises a liquid transfer unit and a heating unit. A side wall of the liquid transfer unit is provided with at least one liquid inflow surface.

The heating unit comprises an embedded part and an atomization part which are of an integrated structure or are connected fixedly.

The embedded part is embedded in the liquid transfer unit and corresponds to the liquid inflow surface to preheat liquid around the liquid inflow surface; and the atomization part is attached to or inlaid in an atomization surface disposed at a bottom and/or a side wall of the liquid transfer unit.

Further, at least one liquid inlet is transversely formed in the side wall of the liquid transfer unit, and an inner wall surface of the liquid inlet forms the liquid inflow surface corresponding to the embedded part. Further, at least one liquid inlet is longitudinally formed in the side wall of the liquid transfer unit, and a side wall surface of the liquid inlet forms the liquid inflow surface corresponding to the embedded part. Further, the heating unit comprises a heating wire and electrode connection members connected to the heating wire, part of the heating wire is embedded in the liquid transfer unit to form the embedded part, and part of the heating wire is inlaid in or attached to a surface of the side wall and/bottom of the liquid transfer unit to form an atomization part.

Further, in the heating atomization assembly, preferably, the atomization surface is a planar surface, a curved surface, or a combination of at least two said planar surface or at least two said curved surfaces, and the atomization part is matched with the atomization surface in shape, and is inlaid in or attached to the atomization surface.

Further, in the heating atomization assembly, preferably, one said atomization surface is disposed on the side wall of the liquid transfer unit, and the atomization surface disposed on the side wall of the liquid transfer unit is away from the liquid inlet formed in the side wall of the liquid transfer unit; or, at least two said atomization surfaces are arranged on the side wall of the liquid transfer unit at intervals, and are staggered with the liquid inlet formed in the side wall of the liquid transfer unit or are all away from the liquid inlet formed in the side wall of the liquid transfer unit.

Further, in the heating atomization assembly, preferably, the atomization surface is disposed on a bottom surface of the liquid transfer unit, and the atomization part is attached to or inlaid in the bottom of the liquid transfer unit.

Further, in the heating atomization assembly, preferably, the atomization surface and the atomization part extend to all or part of the side wall of the liquid transfer unit, such that the atomization surface and the atomization part are each of a half-surrounded structure.

Further, in the heating atomization assembly, preferably, at least one notch is formed in the side wall of the liquid transfer unit and longitudinally extends through the liquid transfer unit, and the notch extends from the bottom of the liquid transfer unit to a top of the liquid transfer unit to form a steam passage.

Further, in the heating atomization assembly, preferably, the atomization part is attached into the notch, and an inner surface of the notch forms the atomization surface.

A heating atomization device, comprising a sealing element, a base, and the above-described heating atomization assembly disposed between the base and the sealing element. The base is provided with an air inlet port in communication with the atomization surface of the heating atomization assembly.

Further, in the heating atomization device, preferably, the heating atomization assembly is inlaid in the sealing element, liquid inlet ports and a hollow air guide nozzle are formed in a top of the sealing element, the liquid inlet ports are in communication with the liquid inflow surface of the liquid transfer unit, and the air guide nozzle is in communication with the atomization surface of the liquid transfer unit.

Further, in the heating atomization device, preferably, the sealing element cooperates with the liquid transfer unit to form at least one atomization chamber.

Further, in the heating atomization device, preferably, protrusions are disposed at sides of the top of the liquid transfer unit, and are in close fit and inserted into the sealing element, such that the liquid transfer unit and the sealing element are sealed.

A heating atomization device comprises a support configured for air guiding and fixing, an electrode assembly, and the above-described heating atomization assembly disposed between the support and the electrode assembly. The support cooperates with the electrode assembly to clamp and fix the heating atomization assembly, and the electrode assembly is electrically connected to the heating unit of the heating atomization assembly.

Further, in the heating atomization device, preferably, the support comprises an air guide part of a hollow and long tubular structure and a mounting part for fixing the heating atomization assembly, the air guide part is in communication with the atomization surface of the heating atomization assembly, and a liquid guide port is formed in a side wall of the mounting part and corresponds to the liquid inflow surface of the heating atomization assembly.

Further, in the heating atomization device, preferably, an internal shape of the mounting part conforms to a shape of the heating atomization assembly, or a limiting member configured for limiting and fixing the heating atomization assembly is disposed on an inner wall of the mounting part.

Further, in the heating atomization device, preferably, the air guide part and the mounting part are of an integrated structure; or, the air guide part and the mounting part are separate structures and are connected fixedly or detachably.

Further, in the heating atomization device, preferably, the electrode assembly comprises two heating atomization electrodes, a base electrode in seal connection with the support, and a battery connection electrode, and an insulating element configured for insulating the base electrode from the battery connection electrode disposed between the base electrode and the battery connection electrode; and the two heating atomization electrode are connected to the base electrode and the battery connection electrode respectively.

Further, in the heating atomization device, preferably, an air inlet is formed in a side wall of the base electrode.

Further, in the heating atomization device, preferably, liquid guide cotton is disposed between the support and the heating atomization assembly for guiding liquid to flow in uniformly and sealing a gap between the support and the heating atomization assembly.

Further, in the heating atomization device, preferably, the liquid guide cotton corresponds to the liquid inflow surface of the liquid transfer unit.

Further, in the heating atomization device, preferably, the liquid guide cotton extends to all or part of the top of the liquid transfer unit to form a half-surrounded structure.

An electronic atomizer comprises an atomizer shell. The above-described heating atomization device is disposed in the atomizer shell. A liquid storage chamber and an air guide tube are disposed between the atomizer shell and the heating atomization device, the liquid storage chamber is in communication with the liquid inlet ports, and the air guide tube is in communication with the air guide nozzle.

An electronic atomizer comprises a liquid chamber outer tube. The above-described heating atomization device is disposed in the liquid chamber outer tube. A liquid storage chamber is disposed between the liquid chamber outer tube and the heating atomization device and is in communication with the liquid guide port, a hollow nozzle is connected to a top of the air guide part of the support, and the liquid storage chamber is sealed by the nozzle, the liquid chamber outer tube and the support.

The invention has the following beneficial effects: according to the heating atomization assembly, the heating atomization device, and the electronic atomizer comprising the heating atomization device provided by the invention, the heating unit comprises the embedded part and the atomization part, the embedded part corresponds to the liquid inflow surface of the liquid transfer unit and is embedded in the liquid transfer unit to preheat liquid around the liquid inflow surface, so as to reduce the viscosity of the liquid with a high viscosity and increase the flow rate of the liquid, such that liquid can be supplemented to the atomization surface quickly, core burning is avoided, and smoking experience is improved; the liquid inflow surface and the atomization surface are disposed on the side surface or/and bottom surface, and the whole heating atomization assembly is made into a cylindrical structure, thus being high in strength and not prone to damage when assembled and used; and when the atomization surfaces are disposed on both sides or on both the side surface and the bottom surface, the atomization area can be enlarged under the condition that the size is limited, and the atomization efficiency is improved.

### BRIEF DESCRIPTION OF THE DRAWINGS

The invention will be further described below in conjunction with accompanying drawings and embodiments. In the drawings,

FIG. 1 is a three-dimensional structural view of a heating atomization assembly according to a first implementation of Embodiment 1 of the invention;

FIG. 2 is a sectional view of the heating atomization assembly according to the first implementation of Embodiment 1 of the invention;

FIG. 3 is a three-dimensional structural view of a heating atomization assembly according to a second implementation of Embodiment 1 of the invention;

FIG. 4 is a front view of the heating atomization assembly according to the second implementation of Embodiment 1 of the invention;

FIG. 5 is a sectional view of the heating atomization assembly according to the second implementation of Embodiment 1 of the invention;

FIG. 6 is a three-dimensional structural view of a heating atomization assembly according to a third implementation of Embodiment 1 of the invention;

FIG. 7 is a three-dimensional structural view of a heating atomization assembly according to a fourth implementation of Embodiment 1 of the invention;

FIG. 8 is a front view of the heating atomization assembly according to the fourth implementation of Embodiment 1 of the invention;

FIG. 9 is a side view of the heating atomization assembly according to the fourth implementation of Embodiment 1 of the invention;

FIG. 10 is a sectional view of a heating atomization assembly according to a fifth implementation of Embodiment 1 of the invention;

FIG. 11 is a sectional view of a heating atomization assembly according to a sixth implementation of Embodiment 1 of the invention;

FIG. 12 is a front sectional view of a heating atomization assembly according to a seventh implementation of Embodiment 1 of the invention;

FIG. 13 is a front sectional view of a heating atomization assembly according to an eighth implementation of Embodiment 1 of the invention;

FIG. 14 is an exploded view of a heating atomization device according to Embodiment 2-1 of the invention;

FIG. 15 is a front sectional view of the heating atomization device according to Embodiment 2-1 of the invention;

FIG. 16 is a side sectional view of the heating atomization device according to Embodiment 2-1 of the invention;

FIG. 17 is an exploded view of a heating atomization device according to Embodiment 2-2 of the invention;

FIG. 18 is a front sectional view of the heating atomization device according to Embodiment 2-2 of the invention;

FIG. 19 is an exploded structural view of an electronic atomizer according to Embodiment 3-1 of the invention;

FIG. 20 is a front sectional view of the electronic atomizer according to Embodiment 3-1 of the invention;

FIG. 21 is a side sectional view of the electronic atomizer according to Embodiment 3-1 of the invention;

FIG. 22 is an exploded structural view of an electronic atomizer according to Embodiment 3-2 of the invention;

FIG. 23 is a front sectional view of the electronic atomizer according to Embodiment 3-2 of the invention; and

FIG. 24 is a side sectional view of the electronic atomizer according to Embodiment 3-2 of the invention.

### DESCRIPTION OF THE EMBODIMENTS

For a better understanding of the technical features, purposes and effects of the invention, the specific implementations of the invention will be described in detail with reference to the accompanying drawings.

When one element is referred to as being “fixed to” or “disposed on” the other element, it may be directly or indirectly located on the other element, or one or more intermediate elements may exist between these two elements. When one element is referred to as being “connected to” the other element, it may be directly or indirectly connected to the other element.

Terms such as “upper”, “lower”, “left”, “right”, “front”, “back”, “vertical”, “horizontal”, “top”, “bottom”, “inner” and “outer” are used to indicate directional or positional relations, and configuration and operation in specific directions based on the accompanying drawings merely for the purpose of facilitating the description of the technical solution of the invention, and should not be construed as limitations of the technical solution of the invention. Terms such as “first” and “second” in the specification are merely for the purpose of conveniently describing the technical solution of the invention, and should not be construed as indicating or implying relative importance or implicitly indicating the number of technical features referred to. “Multiple” means two or more, unless otherwise expressly and specifically defined.

### Embodiment 1

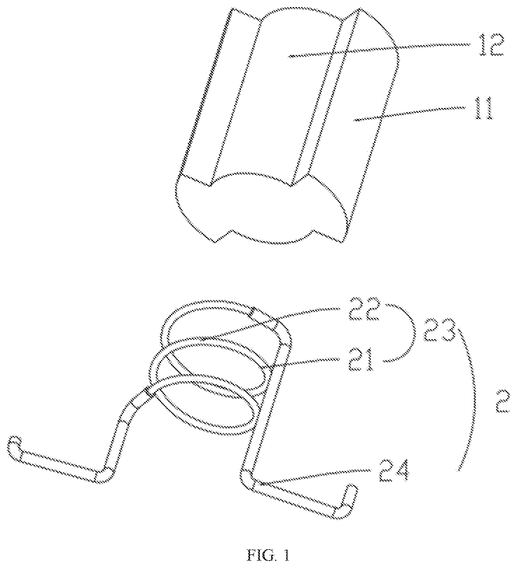

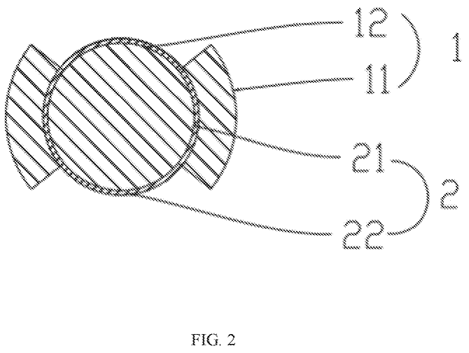

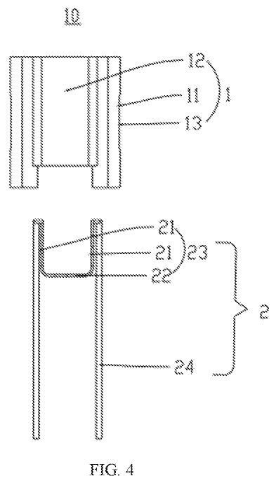

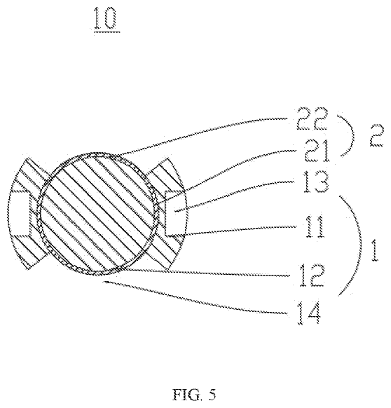

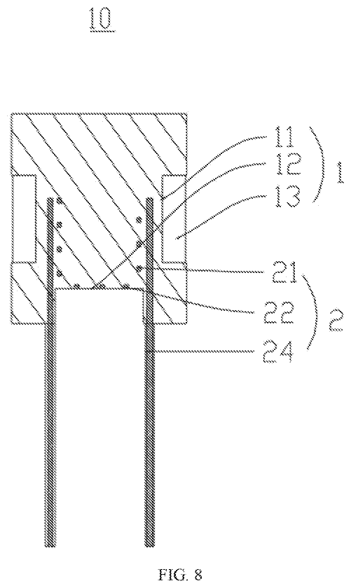

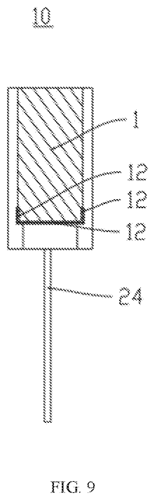

As shown in FIG. 1-FIG. 13, a heating atomization assembly 10 comprises a liquid transfer unit 1 and a heating unit 2. The liquid transfer unit 1 is provided with at least one liquid inflow surface 11 at a side wall thereof. One or more liquid inflow surfaces 11 may be arranged at the side wall of the liquid transfer unit 1, and liquid enters the liquid transfer unit 1 through the liquid inflow surface 11. The heating unit 2 comprises an embedded part 21 and an atomization part 22 which are of an integrated structure or are connected fixedly. That is, the embedded part 21 and the atomization part 22 may be of an integrated structure and formed integrally when produced, such that assembly steps are omitted; or, the embedded part 21 and the atomization part 22 may be separate structures and connected together fixedly. The embedded part 21 is embedded in the liquid transfer unit 1, and the atomization part 22 is attached to or inlaid in an atomization surface 12 disposed at the bottom and/or side wall of the liquid transfer unit 1. When the heating atomization assembly is fabricated, the heating unit 2 is placed and fixed in a mold, then liquid transfer slurry is poured into the mold to form an integrated structure of the heating unit 2 and the liquid transfer unit 1 such that the embedded part 21 of the heating unit 2 is embedded in the liquid transfer unit 1 and the atomization part 22 is attached to or inlaid in the bottom or/and side wall of the liquid transfer unit 1. The heating atomization assembly 10 is made into a cylindrical configuration, which compared with a bowl-shaped configuration or a tubular configuration, is high in strength and not prone to damage when assembled and used. The embedded part 21 is arranged to correspond to the liquid inflow surface 11 and preheats liquid around the liquid inflow surface 11 to reduce the viscosity of the liquid with a high viscosity and increase the flow rate of the liquid in the liquid transfer unit 1, such that the liquid can be quickly supplemented to the atomization surface 12. The atomization part 22 is attached to or inlaid in the atomization surface 12 at the bottom and/or side wall of the liquid transfer unit 1, that is, the atomization part 22 is attached to or inlaid in the bottom of the liquid transfer unit 1, or is attached to or inlaid in the side wall of the liquid transfer unit 1, or is attached to or inlaid in both the bottom and side wall of the liquid transfer unit 1, and the atomization surface 12 is formed on the surface of the bottom and/or side wall of the liquid transfer unit I correspondingly.

The implementation process of the heating atomization assembly 10 is as follows: when the heating atomization assembly 10 works, liquid enters the liquid transfer unit 1 through the liquid inflow surface 11 and is transferred towards the atomization surface 12; when the liquid is transferred to the embedded part 21 of the heating unit 2, the embedded part 21 of the heating unit 2 generates heat to preheat the liquid around the liquid inflow surface 11 of the liquid transfer unit 1 to reduce the viscosity of the liquid with a high viscosity and increase the flow rate of the liquid, such that the liquid is quickly supplemented to the atomization surface 12; the atomization part 22 generates heat at the same time to atomize the liquid on the atomization surface 12 into steam which is mixed with air entering the heating atomization assembly 10 to form aerosol. Due to arrangement of the embedded part 21 and the atomization part 22 and the atomization part 22 corresponding to the liquid inflow surface 11, the liquid supply rate of the heating atomization assembly 10 is increased, thus improving the atomization efficiency and avoiding core burning caused by insufficient liquid supply.

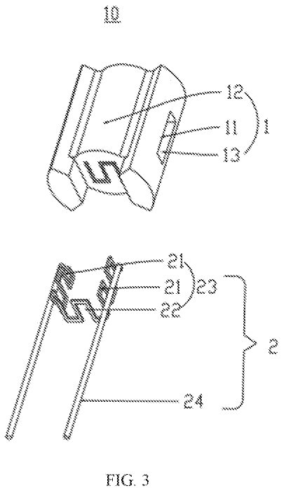

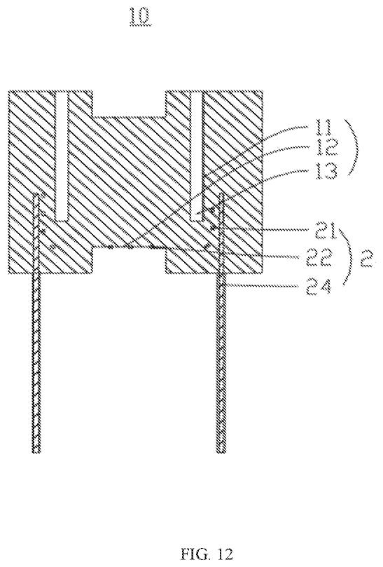

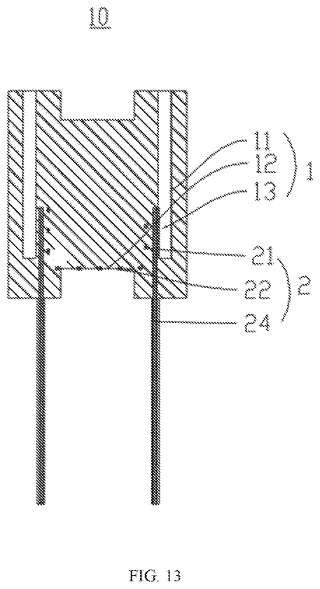

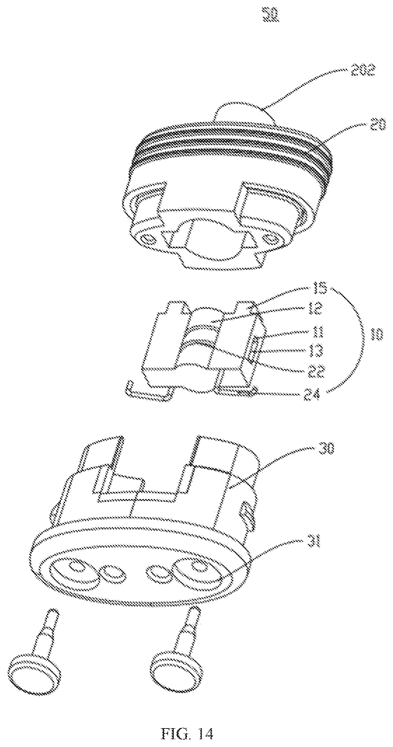

Further, as shown in FIG. 3-FIG. 8, at least one liquid inlet 13 is transversely formed in the side wall of the liquid transfer unit 1, and an inner wall surface, particularly a bottom surface, of the liquid inlet 13 forms the liquid inflow surface 11. As shown in FIG. 12-FIG. 13, at least one liquid inlet 13 is longitudinally disposed in the side wall of the liquid transfer unit 1, and a side wall surface of the liquid inlet 13 forms the liquid inflow surface 11; and the longitudinally-disposed liquid inlet 13 may be located at an inner side or located at outer side of the embedded part 21 and close to the embedded part 21. One or more liquid inlets 13 may be formed in the side wall of the liquid transfer unit 1, and in case of multiple liquid inlets 13, the multiple liquid inlets 13 are arranged at intervals, such that liquid can enter the liquid transfer unit 1 at different positions, the liquid inflow rate is increased, and liquid can enter the liquid transfer unit 1 uniformly. The diameter and shape of the liquid inlet 13 are not limited, and the liquid inflow surface 11 corresponds to the embedded part 21. Through the liquid inlet 13, liquid can enter the liquid transfer unit 1 more rapidly, and the superficial area of the liquid inflow surface 11 is enlarged, such that the contact area between the liquid and the liquid transfer unit 1 is larger; moreover, the liquid inflow surface 11 corresponds to the embedded part 21, which may mean that the whole liquid inlet 13 faces the embedded part 21 when arranged transversely, or is parallel to or inclines towards the embedded part 21 when arranged longitudinally, such that the distance from the liquid inflow surface 11 to the embedded part 21 is shortened, and the liquid preheating effect is better; and the liquid inlet 13 is equivalent to a small liquid storage chamber formed in the liquid transfer unit 1, such that the liquid inflow rate is increased.

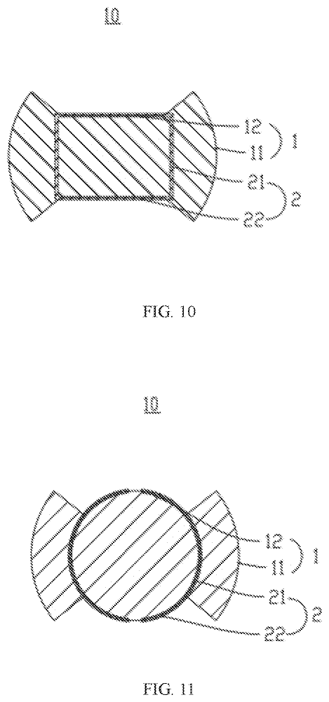

The atomization surface 12 of the liquid transfer unit 1 is a planar surface, a curved surface, or a combination of at least two planar surfaces or curved surfaces. That is, the atomization surface 12 may be a planar surface and a combination of multiple planar surfaces; or, the atomization surface 12 may be a curved surface and a combination of multiple curved surfaces; or, the atomization surface 12 is a combination of planar surfaces and curved surfaces. Correspondingly, the heating unit 2 is matched with the atomization surface 12 in shape. Understandably, as shown in FIG. 10, when the atomization surface 12 is a planar surface, the atomization part 22 of the heating unit 2 is a planar structure matched with the planar atomization surface 12, such that the atomization part 22 can be perfectly attached to or inlaid in the atomization surface 12, and poor contact between the heating unit 2 and the liquid transfer unit 1 is avoided. As shown in FIG. 11, when the atomization surface 12 is a curved surface, the atomization part 22 of the heating unit 2 is a curved structure matched with the curved atomization surface 12, and in this case, the heating unit 2 may be a helical structure, a cylindrical structure or a cylindroid structure, such that the atomization part 22 can be perfectly attached to or inlaid in the atomization surface 12, and poor contact between the heating unit 2 and the liquid transfer unit 1 is avoided. When the atomization surface 12 is a combination of planar surfaces and curved surfaces, the atomization part 22 of the heating unit 2 is a combination of planar surfaces and curved surfaces, which is matched with the atomization surface 12. The heating unit 2 is matched with the atomization surface 12 in shape, such that the atomization part 22 can be perfectly inlaid in or attached to the atomization surface 12 to avoid a poor contact between the heating unit 2 and the atomization surface 12 which affects the atomization effect.

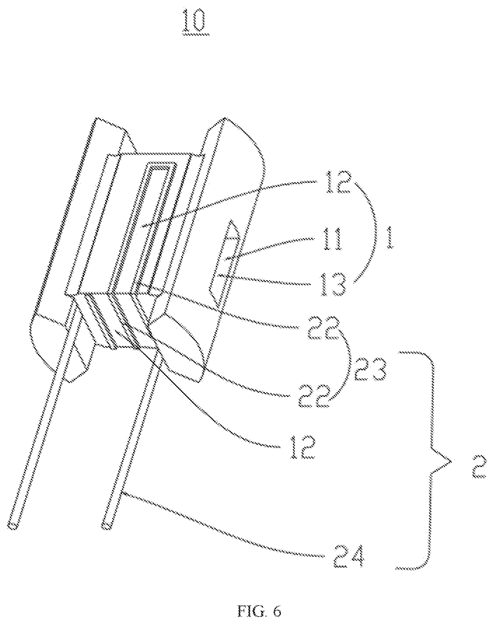

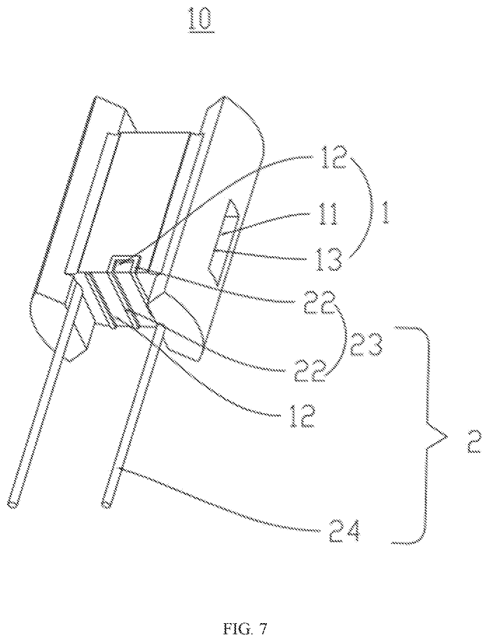

The atomization surfaces 12 of the liquid transfer unit 1 may be one or more. In a specific implementation, the number of the atomization surface 12 is one and the one atomization surface 12 is disposed on the side wall of the liquid transfer unit 1, and the atomization surface 12 disposed on the side wall of the liquid transfer unit 1 is away from the liquid inlet 13 formed in the side wall of the liquid transfer unit 1. Understandably, the heating unit 2 is provided with one atomization part 22 correspondingly, and the atomization part 22 is attached to or inlaid in the side wall of the liquid transfer unit 1 to form the atomization surface 12. The atomization surface 12 being away from the liquid inlet 13 formed in the side wall of the liquid transfer unit 1 means that, when the liquid transfer unit 1 has a polygonal configuration, the atomization surface 12 and the liquid inflow surface 11 are located on different side walls of the liquid transfer unit 1; and when the liquid transfer unit 1 has a curved configuration, the atomization surface 12 and the liquid inflow surface 11 are spaced apart from each other, such that atomization can be controlled easily. In another specific implementation, at least two atomization surfaces 12 are arranged at intervals, and all the atomization surfaces 12 are disposed on the side walls of the liquid transfer unit 1 at intervals, and are staggered with the liquid inlet 13 arranged in the side wall of the liquid transfer unit 1, or the atomization surfaces 12 are all away from the liquid inlet 13. Understandably, the heating unit 2 comprises at least two atomization surfaces 22 correspondingly, the at least two atomization parts 22 are attached on or inlaid in the side wall of the liquid transfer unit 1, the at least two atomization parts 22 are arranged at intervals to form at least two atomization surfaces 12, and the at least two atomization parts 22 are connected in parallel or in series. The atomization parts 22 are staggered with the liquid inlet 13 or the atomization part 22 are away from the liquid inflow surface 11. With respect to the arrangement that the atomization parts 22 are staggered with the liquid inlet 13, in the case where the atomizing parts 22 are all away from the liquid inlet 13, there is no liquid inlet 13 close to any one of the multiple atomizing parts 22. In another specific embodiment, as shown in FIG. 3-FIG. 5, the atomization surface 12 is disposed on the bottom surface of the liquid transfer unit 1, and correspondingly, the atomization part 22 of the heating unit 2 is attached to or inlaid in the bottom of the liquid transfer unit 1. In another specific embodiment, the atomization part 22 disposed at the bottom of the liquid transfer unit 1 extends towards the side wall of the liquid transfer unit 1. As shown in FIG. 6, the atomization part 22 at the bottom of the liquid transfer unit I may extend to the whole side wall of the liquid transfer unit 1. As shown in FIG. 7-FIG. 9, the atomization part 22 may extend to a part of the side wall of the liquid transfer unit 1. The portion of the side wall of the liquid transfer unit 1 along which the atomization part 22 extends, form the atomization surface 12. That is, the atomization surface 12 and the atomization part 22 each extend to all or part of the side wall of the liquid transfer unit 1, such that the atomization surface 12 and the atomization part 22 are each of a half-surrounded structure

The heating unit 2 comprises a heating wire 23 and electrode connection members 24 connected to the heating wire 23. The electrode connection members 24 are connected to electrodes to supply power to the heating wire 23, the heating wire 23 generates heat to preheat liquid in the liquid transfer unit 1 and to atomize liquid on the atomization surface 12 of the liquid transfer unit 1. A part of the heating wire 23 is embedded in the liquid transfer unit 1 to form the embedded part 21, and the embedded part 21 generates heat to preheat liquid around the liquid inflow surface 11 to reduce the viscosity of the liquid and increase the flow rate of the liquid. A part of the heating wire 23 may be inlaid in or attached to the surface of the side wall of the liquid transfer unit 1 to form the atomization part 22. A part of the heating wire 23 may be inlaid in or attached to the surface of the bottom of the liquid transfer unit 1 to form the atomization part 22, or a part of the heating wire 23 may be inlaid in or attached to both the surface of the bottom and the surface of the side wall of the liquid transfer unit 1 to form the atomization part 22. The atomization part 22 generates heat to atomize liquid on the atomization surface 12 to form steam.

Further, preferably, at least one notch 14 is formed in the side wall of the liquid transfer unit 1 and longitudinally extends through the side wall of the liquid transfer unit 1. The number of the notches 14 may be one or more, and in case where multiple notches 14 are formed, the notches 14 are arranged at intervals. The notch 14 communicates the bottom of the liquid transfer unit 1 with the top of the liquid transfer unit 1 to form a steam passage, that is, one or more steam passages may be formed. Understandably, the steam passage extends from the bottom of the liquid transfer unit 1 to the top of the liquid transfer unit 1, and steam formed on the atomization surface 12 flows out of the heating atomization assembly 10 through the steam passage. Further, at least the atomization part 22 of the heating unit 2 is attached into the notch 14, that is, at least the atomization part 22 is attached to or inlaid in the surface of the notch 14, the corresponding surface of the notch 14 forms the atomization surface 12, and steam formed on the atomization surface 12 flows out along the steam passage.

### Embodiment 2-1

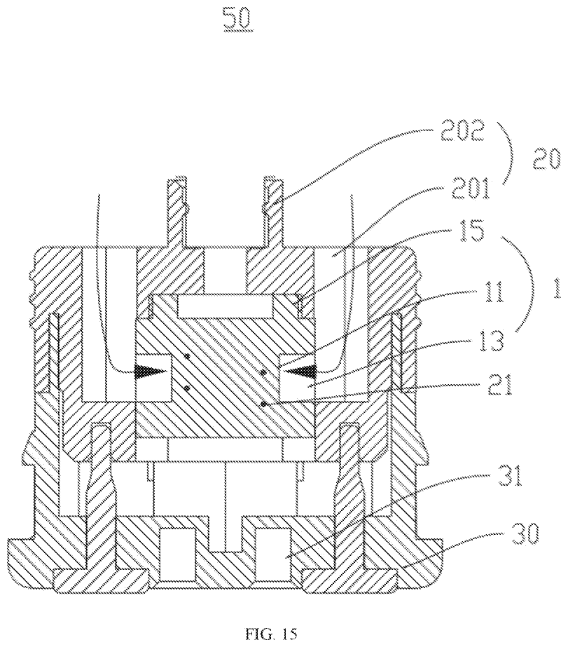

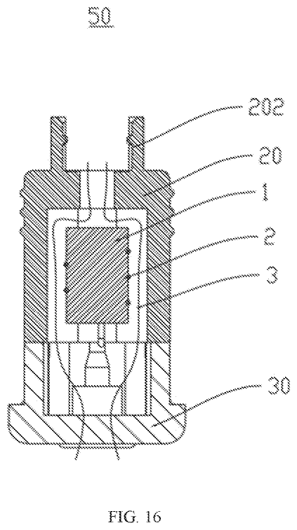

As shown in FIG. 14-FIG. 16, a heating atomization device 50 comprises a sealing element 20, a base 30, and the heating atomization assembly 10 of Embodiment 1 disposed between the base 30 and the sealing element 20. The base 30 cooperates with the sealing element 20 to seal the heating atomization assembly 10, such that liquid is prevented from leaking from the heating atomization assembly 10. Air inlet ports 31 are formed in the base 30 and are communicated with the atomization surface 12 of the heating atomization assembly 10. Air enters the heating atomization assembly 10 through the air inlet ports 31 in the base 30, flows to the atomization surface 12 of the heating atomization assembly 10, and is mixed with steam formed on the atomization surface 12 to form aerosol. The heating atomization assembly 10 is inlaid in the sealing element 20, liquid inlet ports 201 and a hollow air guide nozzle 202 are formed in the top of the sealing element 20, the liquid inlet ports 201 are communicated with the liquid inflow surface 11 of the liquid transfer unit 1, and liquid enters the heating atomization assembly 10 through the liquid inlet ports 201 in the sealing element 20, flows to the liquid inflow surface 11 of the liquid transfer unit 1, and is guided to the atomization surface 12 of the liquid transfer unit 1 to be atomized by the heating unit 2 on the atomization surface 12 to form steam which is mixed with air to form aerosol. The air guide nozzle 202 is communicated with the atomization surface 12 of the liquid transfer unit 1, and the aerosol formed on the atomization surface 12 flows to the air guide nozzle 202 and then flows out of the heating atomization device 50. The sealing element 20 cooperates with the liquid transfer unit 1 to form at least one atomization chamber 3. At least one notch 14 is formed in the side wall of the liquid transfer unit 1 and longitudinally penetrates through the liquid transfer unit 1, the notch 14 cooperates with the sealing element 20 to form an atomization chamber 3. The steam formed on the atomization surface 12 is gathered in the atomization chamber 3, such that the steam flowing out of the atomization chamber 3 has a high concentration. Protrusions 15 are disposed at the sides of the top of the liquid transfer unit 1, recesses matched with the protrusions 15 are formed in the sealing element 20, and the protrusions 15 are inserted into and in close fit with the recesses of the sealing element 20, such that the liquid transfer unit 1 and the sealing element 20 are sealed.

The implementation process of the heating atomization device 50 is as follows: when the heating atomization device 50 works, air enters the heating atomization assembly 10 through the air inlet ports 31 in the base 30, liquid enters the heating atomization assembly 10 through the liquid inlet ports 201 in the sealing element 20 and flows to the liquid inflow surface 11 of the heating atomization assembly 10 to be preheated by the embedded part 21 on the liquid inflow surface 11, the liquid is then guided to the atomization surface 12 and is atomized by the atomization part 22 on the atomization surface 12 to form steam, which is mixed with air entering the heating atomization assembly 10 to form aerosol, and the aerosol is gathered in the atomization chamber 3 to form aerosol with a high concentration, which then flows out through the air guide nozzle 202 of the sealing element 20.

Other parts of the heating atomization device 50 belong to the prior art, and will not be detailed here.

### Embodiment 2-2

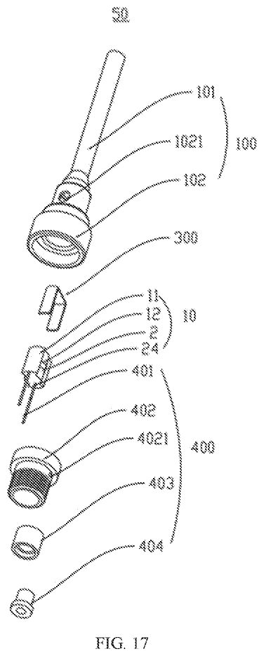

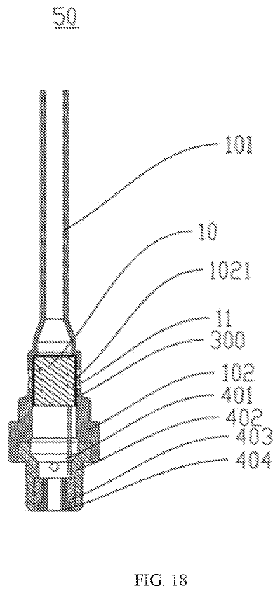

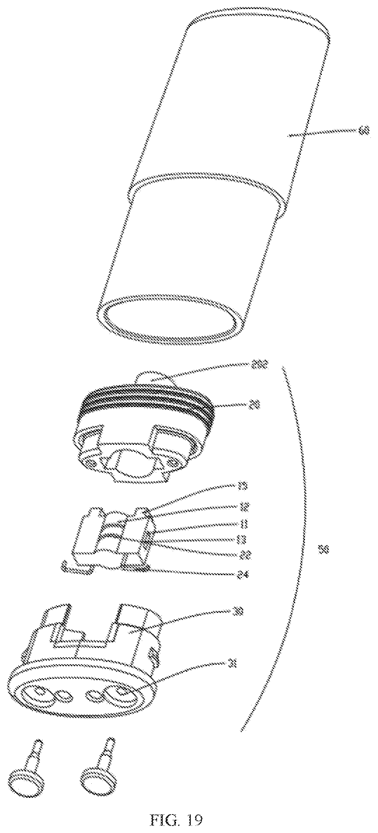

As shown in FIG. 17-FIG. 18, a heating atomization device 50 comprises a support 100 used for air guiding and fixing, an electrode assembly 400, and the heating atomization assembly 10 of Embodiment 1 disposed between the support 100 and the electrode assembly 400. The support 100 cooperates with the electrode assembly 400 to clamp and fix the heating atomization assembly 10, the electrode assembly 400 is electrically connected to the heating unit 2 of the heating atomization assembly 10 and supplies power to the heating unit 2. The electrode assembly 400 comprises two heating atomization electrodes 401, a base electrode 402 in seal connection with the support 100, and a battery connection electrode 404 and an insulating element 403 disposed between the base electrode 402 and the battery connection electrode 404 and configured for insulating the base electrode 402 from the battery connection electrode 404. The heating atomization electrodes 401 are connected to the electrode connection members 24 of the heating unit 2. The base electrode 402 is provided with a threaded connector. The base electrode 402 is threadedly connected to an electrode of a battery. The battery connection electrode 404 is in contact with the electrode of the battery. The two heating atomization electrodes 401 are connected to the base electrode 402 and the battery connection electrode 404 respectively. An air inlet 1021 is formed in a side wall of the base electrode 402 and is in communication with the atomization surface 12 of the heating atomization assembly 10, and air enters the heating atomization assembly 50 through the air inlets 1021. Through arrangement of the support 100, the electrode assembly 400 and the heating atomization assembly 10, the overall structure of the heating atomization device 50 is smaller and more compact.

The support 100 comprises an air guide part 101 of a hollow and long tubular structure and a mounting part 102 used for fixing the heating atomization assembly 10. The air guide part 101 is in communication with the atomization surface 12 of the heating atomization assembly 10 to form an air guide passage. Steam formed on the atomization surface 12 flows out through the air guide part 101. A liquid guide port 1021 is formed in a side wall of the mounting part 102, liquid enters the mounting part 102 of the support 100 through the liquid guide port 1021, and the liquid guide port 1021 corresponds to the liquid inflow surface 11 of the heating atomization assembly 10. In order to fix the heating atomization assembly 10 in the mounting part 102 and to prevent the heating atomization assembly 10 from shaking under the action of external force, the internal shape of the mounting part 102 is designed to conform to the shape of the heating atomization assembly 10, or a limiting member (not shown) configured for limiting and fixing the heating atomization assembly 10 is disposed on an inner wall of the mounting part 102. The limiting member may be a locking groove, a limiting pillar, or the like, and the invention has no specific limitation in this aspect. The air guide part 101 and the mounting part 102 are of an integrated structure and are formed integrally when produced, such that assembly steps are omitted. Alternatively, the air guide part 101 and the mounting part 102 are separate structures and are connected fixedly or detachably.

Further, liquid guide cotton 300 is disposed between the support 100 and the heating atomization assembly 10 for guiding fluid to flow in uniformly and a gap between the support 100 and the heating atomization assembly 10. The liquid guide cotton 300 is arranged to correspond to the liquid inflow surface 11 of the liquid transfer unit 1. The structural shape of the liquid guide cotton 300 is not limited, and the liquid guide cotton 300 may be an independent plate-shaped structure, an L-shaped structure, or a structure in other special shapes. Preferably, the liquid guide cotton 300 extends to all or part of the top of the liquid transfer unit 1 to form a half-surrounded structure or an L-shaped structure, which is beneficial to assembly and may prevent that installation of the liquid guide cotton 300 is difficult or the liquid guide cotton 300 deviates when the liquid guide cotton 300 is installed.

The implementation process of the heating atomization device 50 is as follows: when the heating atomization device 50 works, air enters the heating atomization assembly 10 through the air inlet 1021 in the side wall of the base electrode 402, liquid enters the heating atomization assembly 10 through the liquid guide port 1021 in the support 100, flows to the liquid guide cotton 300 which guides the liquid to uniformly flow to the liquid inflow surface 11 of the heating atomization assembly 10, and finally is guided to the atomization surface 12. The battery supplies power to the heating unit 2 through the electrode assembly 400, the liquid on the atomization surface 12 is atomized by the heating unit 2 to form steam, which is mixed with air entering the heating atomization assembly 10 to form aerosol, and then the aerosol flows out through the air guide part 101 of the support 100.

### Embodiment 3-1

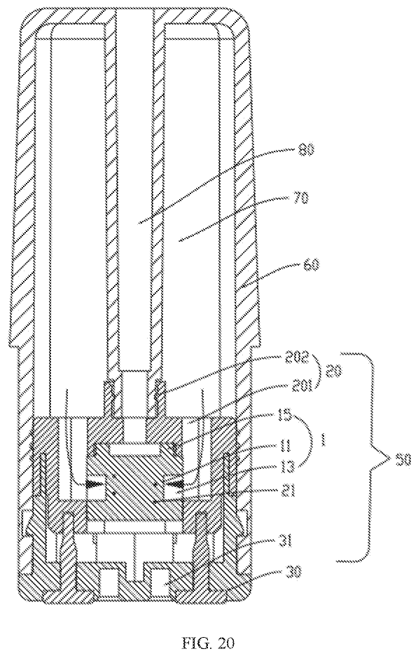

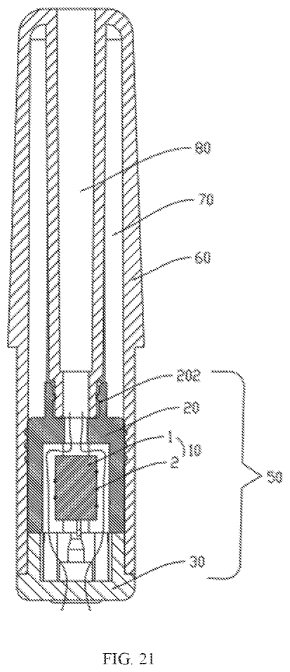

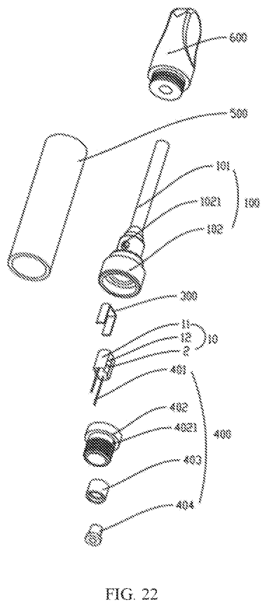

As shown in FIG. 19-FIG. 21, an electronic atomizer comprises an atomizer shell 60. The heating atomization device 50 of Embodiment 2-1 is disposed in the atomizer shell 60. A liquid storage chamber 70 and an air guide tube 80 are disposed between the atomizer shell 60 and the heating atomization device 50. The liquid storage chamber 70 is in communication with the liquid inlet ports 201, and the air guide tube 80 is in communication with the air guide nozzle 202. When the electronic atomizer works, liquid in the liquid storage chamber 70 is supplied to the heating atomization device 50, and the heating unit 2 of the heating atomization device 50 generates heat to atomize the liquid into steam, which flows to the air guide tube 80 and finally flows out of the atomizer shell 60.

Other parts of the electronic atomizer belong to the prior art, and will not be detailed here.

### Embodiment 3-2

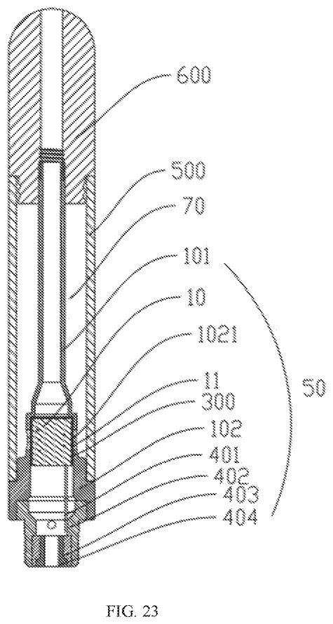

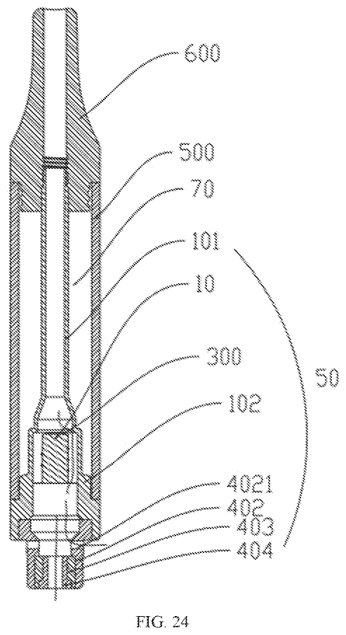

As shown in FIG. 22-FIG. 24, an electronic atomizer comprises a liquid chamber outer tube 500. The heating atomization device 50 of Embodiment 2-2 is disposed in the liquid chamber outer tube 500. A liquid storage chamber 70 is disposed between the liquid chamber outer tube 500 and the heating atomization device 50. Liquid is stored in the liquid storage chamber 70. The liquid storage chamber 70 is in communication with the liquid guide port 1021. A hollow nozzle 600 is connected to the top of the air guide part 101 of the support 100, and the liquid storage chamber 70 is sealed by the nozzle 600, the liquid chamber outer tube 500 and the support 100. When the electronic atomizer works, liquid in the liquid storage chamber 70 is supplied to the heating atomization device 50, and then the heating atomization device 50 generates heat to atomize the liquid into steam, which flows to the nozzle 600 through the support.

Other parts of the electronic atomizer belong to the prior art, and will not be detailed here.

1. A heating atomization assembly, comprising a liquid transfer unit and a heating unit wherein a side wall of the liquid transfer unit is provided with at least one liquid inflow surface;
the heating unit comprises an embedded part and an atomization part which are of an integrated structure or are connected fixedly; and
the embedded part is embedded in the liquid transfer unit and corresponds to the liquid inflow surface to preheat liquid around the liquid inflow surface; and the atomization part is attached to or inlaid in an atomization surface disposed at a bottom and/or a side wall of the liquid transfer unit.

2. The heating atomization assembly according to claim 1, wherein at least one liquid inlet is transversely formed in the side wall of the liquid transfer unit, and an inner wall surface of the liquid inlet forms the liquid inflow surface corresponding to the embedded part.

3. The heating atomization assembly according to claim 1, wherein at least one liquid inlet is longitudinally formed in the side wall of the liquid transfer unit, and a side wall surface of the liquid inlet forms the liquid inflow surface corresponding to the embedded part.

4. The heating atomization assembly according to claim 1, wherein the heating unit comprises a heating wire and electrode connection members connected to the heating wire, part of the heating wire is embedded in the liquid transfer unit to form the embedded part, and part of the heating wire is inlaid in or attached to a surface of the side wall and/bottom of the liquid transfer unit to form an atomization part.

5. The beating atomization assembly according to claim 4, wherein the atomization surface is a planar surface, a curved surface, or a combination of at least two said planar surface or at least two said curved surfaces, and the atomization part is matched with the atomization surface in shape, and is inlaid in or attached to the atomization surface.

6. The heating atomization assembly according to claim 1, wherein one said atomization surface is disposed on the side wall of the liquid transfer unit, and the atomization surface disposed on the side wall of the liquid transfer unit is away from the liquid inlet formed in the side wall of the liquid transfer unit, or, at least two said atomization surfaces are arranged on the side wall of the liquid transfer unit at intervals, and are staggered with the liquid inlet formed in the side wall of the liquid transfer unit or are all away from the liquid inlet formed in the side wall of the liquid transfer unit.

7. The heating atomization assembly according to claim 1, wherein the atomization surface is disposed on a bottom surface of the liquid transfer unit, and the atomization part is attached to or inlaid in the bottom of the liquid transfer unit.

8. The heating atomization assembly according to claim 7, wherein the atomization surface and the atomization part extend to all or part of the side wall of the liquid transfer unit, such that the atomization surface and the atomization part are each of a half-surrounded structure.

9. The heating atomization assembly according to claim 1, wherein at least one notch is formed in the side wall of the liquid transfer unit and longitudinally extends through the liquid transfer unit, and the notch extends from the bottom of the liquid transfer unit to a top of the liquid transfer unit to form a steam passage.

10. The heating atomization assembly according to claim 9, wherein the atomization part is attached into the notch, and an inner surface of the notch forms the atomization surface.

11. (canceled)

12. (canceled)

13. (canceled)

14. (canceled)

15. A heating atomization device, comprising a support configured for air guiding and fixing, an electrode assembly, and the heating atomization assembly according to claim 2 disposed between the support and the electrode assembly, wherein the support cooperates with the electrode assembly to clamp and fix the heating atomization assembly, and the electrode assembly is electrically connected to the heating unit of the heating atomization assembly.

16. The heating atomization device according to claim 15, wherein the support comprises an air guide part of a hollow and long tubular structure and a mounting part for fixing the heating atomization assembly, the air guide part is in communication with the atomization surface of the heating atomization assembly, and a liquid guide port is formed in a side wall of the mounting part and corresponds to the liquid inflow surface of the heating atomization assembly.

17. The heating atomization device according to claim 16, wherein an internal shape of the mounting part conforms to a shape of the heating atomization assembly, or a limiting member configured for limiting and fixing the heating atomization assembly is disposed on an inner wall of the mounting part.

18. The heating atomization device according to claim 16, wherein the air guide part and the mounting part are of an integrated structure; or, the air guide part and the mounting part are separate structures and are connected fixedly or detachably.

19. The heating atomization device according to claim 15, wherein the electrode assembly comprises two heating atomization electrodes, a base electrode in seal connection with the support, and a battery connection electrode, and an insulating element configured for insulating the base electrode from the battery connection electrode disposed between the base electrode and the battery connection electrode; and the two heating atomization electrode are connected to the base electrode and the battery connection electrode respectively.

20. The heating atomization device according to Claim 19, wherein an air inlet is formed in a side wall of the base electrode.

21. The heating atomization device according to claim 16, wherein liquid guide cotton is disposed between the support and the heating atomization assembly for guiding liquid to flow in uniformly and sealing a gap between the support and the heating atomization assembly.

22. The heating atomization device according to claim 21, wherein the liquid guide cotton corresponds to the liquid inflow surface of the liquid transfer unit.

23. The heating atomization device according to claim 22, wherein the liquid guide cotton extends to all or part of the top of the liquid transfer unit to form a half-surrounded structure.

24. (canceled)

25. An electronic atomizer, comprising a liquid chamber outer tube, wherein the heating atomization device according to claim 15 is disposed in the liquid chamber outer tube, a liquid storage chamber is disposed between the liquid chamber outer tube and the heating atomization device and is in communication with the liquid guide port, a hollow nozzle is connected to a top of the air guide part of the support, and the liquid storage chamber is sealed by the nozzle, the liquid chamber outer tube and the support.
